(19) United States
(12) Patent Application Publication
(10) Pub. No.: US 2002/0047094 A1
(43) Pub. Date: Apr. 25, 2002

(54) Stimulable phosphor sheet

(75) Inventor: Yuzuru Ohtsuka, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/983,409

(22) Filed: Oct. 24, 2001

(30) Foreign Application Priority Data
Oct. 24, 2000 (JP) 323735/2000

(51) Int. Cl. G03B 42/02

(52) U.S. Cl. 250/484.4

(57) ABSTRACT

A stimulable phosphor sheet is formed by laminating two substantially identical transparent protective base sheets on either side of a stimulable phosphor layer. By this construction, said sheet requires no distinction of front and back surfaces, and a problem of confusing the front and back surfaces can be eliminated.

### BACKGROUND OF THE INVENTION

1. Field of the Invention

The present invention relates to stimulable phosphor sheets having a stimulable phosphor layer.

2. Description of the Related Art

There are known radiation image recording/reproducing systems which utilize stimulable phosphors (storable phosphors) that store a portion of radiation energy (x-rays, α-rays, β-rays, γ-rays, electron beams, UV rays, etc.) irradiated thereupon. After said irradiation, the stimulable phosphors will, when irradiated by an excitation light such as visible light, emit light corresponding to said stored energy. Radiation image data of, for example, a human subject can be recorded on a sheet comprising such phosphors, after which said sheet can be scanned with an excitation light thereby causing light to be emitted therefrom (Japanese Unexamined Patent Publication Nos. 55(1980)-12429, 56(1981)-11395, 56(1981)-11397, et al).

As a method of photoelectrically reading the light mentioned above, there is known double sided reading, in which the light is read from both sides of stimulable phosphors arranged in a sheet form. Said double sided reading utilizes, for example, a stimulable phosphor sheet which comprises a transparent film with a thickness of 100-700 μm as a substrate and a layer of sheet form stimulable phosphors laminated on a front surface thereof. Said stimulable phosphor sheet is irradiated with radiation on the stimulable phosphor layer side to record radiation image data thereon. Said sheet is then scanned by an excitation light, and the resultant emitted light from the front surface (stimulable phosphor layer side) as well as from the rear surface (transparent substrate side) are each read by photoelectric reading means provided on either side of said stimulable phosphor sheet (Japanese Unexamined Patent Publication No. 55(1980)-87970 et al). By utilizing double sided reading such as described above, an addition process can be executed on signals obtained from both sides corresponding to individual pixels, thereby improving the light condensing efficiency, as well as the S/N ratio, as the noise elements are averaged out.

Further, in the radiation image recording/reproducing apparatus described above, for example, radiation photography can be performed on a stimulable phosphor sheet housed in a planar cassette. In the case that the photographed image is to be read, a method has been adopted in which the cassette is mounted in a automatic reading apparatus, which automatically opens the cassette, takes out the stimulable phosphor sheet, and performs a readout operation.

However, in the case that the stimulable phosphor sheet is, as described above, composed of a transparent substrate having a stimulable phosphor layer laminated on a front surface thereof, because the substrate is transparent, it is difficult to determine the front and back of said sheet. For example, when said sheet is to be housed in a cassette, although the sheet should be housed so that the front surface of the stimulable phosphor sheet faces the same direction as the front side of the cassette (the side which faces the radiation source), it is easy to house the stimulable phosphor sheet backwards—that is, with the front and back surfaces reversed.

As the reading apparatus described above operates on the premise that the stimulable phosphor sheet is housed in the cassette properly—that is, with the front surface facing the radiation source, accordingly it executes the addition process on the front side image signal and the back side image signal with a predetermined addition ratio. If the stimulable phosphor sheet is housed in the cassette with the front and back surfaces reversed, the addition ratio would then be reversed for the front surface image signal and the back surface image signal. In this case, there arises the problem that the image which represents image signals obtained by adding said two image signals has reduced sharpness.

### SUMMARY OF THE INVENTION

It is an object of the present invention, in consideration of the above described circumstances, to provide a stimulable phosphor sheet which avoids problems of reversing the front and back surfaces thereof.

The stimulable phosphor sheet of the present invention is characterized by being composed of two substantially identical transparent protective base sheets and a stimulable phosphor layer sandwiched therebetween.

Because the stimulable phosphor sheet of the present invention is structured as substantially identical transparent protective base sheets sandwiching a stimulable phosphor layer therebetween, the front and back surfaces of said stimulable phosphor layer become substantially similar, and a need to distinguish front and back surfaces thereof when it is to be used is eliminated. In other words, as the front and back surfaces are substantially similarly usable, no problem of reverse installation in a cassette arises, thereby eliminating also the problem of reduced sharpness at the image signal processing step which arises from such reverse installation. A good image can therefore be consistently obtained.

### BRIEF DESCRIPTION OF THE DRAWINGS

FIG. 1 is a perspective view which shows the structure of the stimulable phosphor sheet of the present invention.

FIG. 2 is a schematic diagram which shows a reading apparatus which performs double sided reading from a stimulable phosphor sheet.

### DESCRIPTION OF THE PREFERRED EMBODIMENTS

Hereinafter, the embodiments of the present invention will be described in detail, with reference to the drawings.

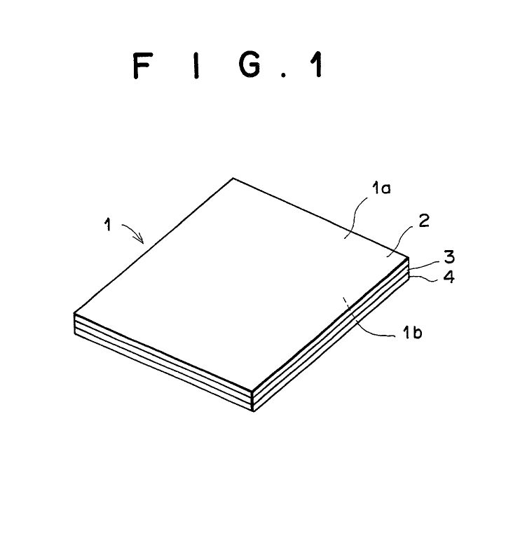

As shown in FIG. 1, the stimulable phosphor sheet 1 of the present invention is constituted by a first colorless transparent protective base sheet 2 which transmits phosphorescent light, a sheet form stimulable phosphor layer (BaFBrI:Eu) 3 laminated on a surface of said protective base sheet 2, and a second colorless transparent protective base sheet 4 which transmits phosphorescent light laminated on said stimulable phosphor layer 3. The first protective base sheet 2 and the second protective base sheet 4 are identical with respect to material and thickness. With regard to the stimulable phosphor sheet 1, the surface on the side of protective base sheet 2 and the surface on the side of protective base sheet 4 are identical. A transparent substrate composed of, for example, PET or PEN is utilized for the protective base sheets 2 and 4.

Specifically, the phosphor layer 3 which contains accelerated phosphorescent particles is pressed onto the protective base sheet 2 which is a transparent substrate made of PEN or PET via an adhesive layer. Then, a protective base sheet 4 which is a transparent substrate identical to the protective base sheet 2 (the lower layer to said phosphor layer) is pressed onto said phosphor layer 3 as an upper layer thereof, via an adhesive layer. In this manner, a stimulable phosphor sheet having identical structures on the front and back surfaces thereof is formed. Note that the phosphor layer can be formed by spreading on the base sheet.

Further, a layer made of a material such as fluorocarbon resinf can be added to the surface of the stimulable phosphor sheet 1 to prevent dirt and damage, or a layer to improve the electroconductive property can be added to the interior thereof. It is possible to improve the performance of said sheet by the incorporation of such additions thereto.

By this construction, there is no distinction between the front and back surfaces of the stimulable phosphor sheet 1 of the present invention, and as either can be used as the front surface, the troublesome determination between the front and back surfaces is eliminated.

Next, a specific example of double sided reading of the stimulable phosphor sheet of the present invention will be described.

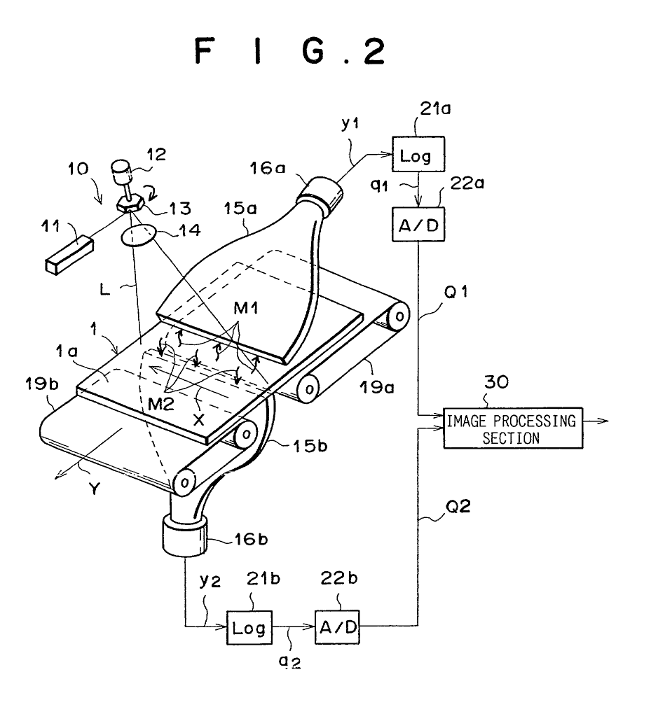

FIG. 2 is a schematic diagram which shows an example of a radiation image reading apparatus which performs the readout of radiation image data stored on the stimulable phosphor sheet of the present invention. The reading apparatus shown in the figure reads the radiation image data stored on the stimulable phosphor layer 3 of the stimulable phosphor sheet of FIG. 1, from each surface thereof. Hereinafter, for the sake of simplicity, the first protective base sheet 2 side of the stimulable phosphor sheet 1 will be referred to as front surface 1a, and the second protective base sheet 4 side as the back surface. However, this can be reversed.

With regard to the reading apparatus shown in the figure, the stimulable phosphor sheet 1 having radiation image data recorded thereon is set in a predetermined position on the endless belt 19a, with the first protective base sheet side surface 1a (hereinafter referred to as front surface 1a) faceup. Said sheet is conveyed in the direction indicated by arrow Y (vertically scanned) by endless belts 19a and 19b, driven by a motor (not shown).

Meanwhile, laser light L, emitted from light source 11 as an excitation light is reflectively deflected by a rotating multiple face mirror 13 which is driven by a motor 12 and rotates at high speed in the direction indicated by the arrow. Said light L is converged by scanning lens 14 above the surface of the stimulable phosphor sheet 1 while being scanned at an equal speed, and performs a main scan of the front surface 1a in the direction indicated by the arrow X. By the main scan performed by laser light L and the vertical scanning performed by the conveyance of stimulable phosphor sheet 1, laser light L is irradiated over the entire surface of stimulable phosphor sheet 1.

The laser light L that irradiates stimulable phosphor sheet 1 excites the stimulable phosphor layer 3 thereof, and a phosphorescent light M1 corresponding to the radiation image data recorded thereon is emitted from the front surface 1a of the stimulable phosphor sheet 1. At the same time, a phosphorescent light M2 corresponding to the radiation image data recorded in the stimulable phosphor is emitted from the second protective base sheet side (hereinafter referred to as back surface 1b).

The phosphorescent light M1, M2 emitted from the front surface 1a and back surface 1b of the stimulable phosphor sheet 1 are led to photomultipliers 16a, 16b by condensing guides 15a, 15b provided near said surfaces, and is photoelectrically detected by said photomultipliers 16a, 16b. Condensing guides 15a, 15b are made by forming a material that has a photoconductive property, such as acrylic board. Said condensing guides 15a, 15b are situated so that their straight line form light receiving surfaces extend along the main scanning line of stimulable phosphor sheet 1. The annularly formed light emission surfaces thereof are mated with the light receiving surfaces of photomultipliers 16a, 16b. The phosphorescent light M1, M2 enters condensing guides 15a, 15b through the aforementioned light receiving surfaces, travels through the interior of said condensing guides 15a, 15b by total reflection, are emitted from the light emission surfaces thereof and are received by the photomultipliers 16a, 16b. The quantity of phosphorescent light M1, M2 which represent radiation image data are converted to analog image signals y1, y2 by the photomultipliers 16a, 16b.

The analog signals y1, y2 output by photomultipliers 16a, 16b are logarithmically amplified by logarithm amplifiers 21a, 21b and converted to logarithm image signals q1, q2. The logarithmically amplified logarithm image signals q1, q2 are input to A/D conversion circuits, where they are sampled at a predetermined sampling frequency T and converted to digital image data Q1, Q2, which are then input to the image processing section 30.

The image processing section 30 performs weighted addition on the image data Q1 and Q2 in pairs that correspond to individual pixels utilizing a preset addition ratio. The image signal Q for each pixel obtained by said addition undergoes further processes such as a gradation process, a frequency process, etc., then is output to an external image reproduction apparatus or the like. An addition ratio best suited for suppressing noise is used for the aforementioned front and back surfaces.

Note that in the above description, the stimulable phosphor sheet of the present invention has been described as that to be used in double side reading. However, the present invention is not limited to this, and the stimulable phosphor sheet may also be used in a single side reading, in which only the phosphorescent light emitted from one side thereof is read.

What is claimed is:

1. a stimulable phosphor sheet comprising:
two substantially identical transparent protective base sheets, and
a stimulable phosphor layer sandwiched between said transparent protective base sheets.
